(19) United States
(12) Patent Application Publication
(10) Pub. No.: US 2010/0073599 A1
(43) Pub. Date: Mar. 25, 2010

(54) LIQUID CRYSTAL DISPLAY DEVICE AND BACKLIGHT MODULE THEREOF

(76) Inventors: Daekeun YOON, Beijing (CN); Sangjig LEE, Beijing (CN); Young JEONG, Beijing (CN)

Correspondence Address: LADAS & PARRY LLP, 224 SOUTH MICHIGAN AVENUE, SUITE 1600, CHICAGO, IL, 60604, US

(21) Appl. No.: 12/561,376

(22) Filed: Sep. 17, 2009

(30) Foreign Application Priority Data
Sep. 19, 2008 (CN) 200810222549.X

(51) Int. Cl. G02F 1/13357; G09F 13/04

(52) U.S. Cl. 349/64; 362/97.2

(57) ABSTRACT

A backlight module for a liquid crystal display, comprising: a light guiding plate comprising one or more incident surface and one light emitting surface; a reflecting film provided on a side of the light guiding plate opposite to the light emitting surface; and a reflecting type polarizing plate disposed directly on the light emitting surface of the light guiding plate and comprising a metal grating.

### BACKGROUND

Embodiments of the present invention relate to a backlight module capable of implementing light reflection circulation and a liquid crystal display having such a backlight module.

A liquid crystal display (LCD) is not a self emitting display device, for illuminating which a backlight module is provided. According to the position of a light source in a backlight module, a backlight module can be an edge light type backlight module or a direct light backlight module. As edge light type backlight modules provide more advantages of slimness, the edge light type backlight modules are widely used for manufacturing LCDs.

FIG. 1 is a cross sectional view of a LCD having a conventional edge light type backlight module. The LCD comprises a cover 4, a display panel 2, polarizing plates, and a backlight module 1. The polarizing plates are disposed on the upper side and lower side of the LCD display panel 2, and at least comprise an upper polarizing plate 3 and a lower polarizing plate (not shown), whose functions are to provide polarized light. The backlight module 1 comprises, among others, a frame 11, a light source 12 (for example a cold cathode fluorescence lamp (CCFL) or light emitting diodes (LEDs)), a light guiding plate (LGP) 15, optical films 20, a reflecting film 14 and a reflecting plate 13. In particular, the frame 11 of the backlight module 1 is provided with a light source 12 at one side thereof. On the inner surface of the frame 11 around the light source 12 is disposed the reflecting plate 13. The light guiding plate 15 is disposed at a side of the light source 12, to transform the line or point light source 12 into surface light source and direct it toward the display panel 2 uniformly. On the light guiding plate 15 are provided the optical films 20, which are made of for example poly(ethylene terephthalate) (PET) films. The optical films 20 optionally comprise a diffusing plate, a prism sheet/brightness enhanced film and the like so as to diffuse the light and condense it inward with respect to the display panel 2. The reflecting plate 14 is disposed under the light guiding plate 15.

Since the light emitting from the light source is limited in amount, the light from the light source has to be fully used to improve the brightness of a LCD, that is, the light utilization efficiency has to be improved.

A polarizing plate is an optical element for changing ordinary light into polarized light whose polarization direction is accurately controlled. The most commonly used polarizing plate is an absorbing type polarizing plate, which allows the light having the same polarizing direction as the polarizing axis of the plate to pass therethrough, while absorbing the other component of the light. Only a portion of the light from the backlight module can pass through the display panel, and the other portion is absorbed. As a result, a large portion, at least 50% percent, of the light from the light source is lost and cannot be used, leading to an extremely low optical efficiency.

Several measures have been proposed with regard to the polarizing plate for improving the light utilization efficiency, and one of them is to use a dual brightness enhancement film (DBEF) film as the polarizing plate. The DBEF film is a multilayer film composed of crystals of different crystallization directions. Depending on the crystallization direction, the topmost layer possesses the property of polarization, and the light not passing the topmost layer is reflected downwardly by the topmost layer and then reflected again by underlying crystal films upwardly, so as to form a circulation to fully use the light. As a result, the optical efficiency is improved, but the cost to obtain such polarizing plate is very high, which makes it unfit and difficult to be used in the commonly used LCD displays.

Besides, there is still the technology of reflecting type polarizing plate. A reflecting type polarizing plate has a metal grating whose pitch is smaller than wavelength of light. A LCD having such a reflecting type polarizing plate is disclosed in the Korea patent application KR2006-0119678.

### SUMMARY

An aspect of the invention provides a backlight module for a liquid crystal display, comprising: a light guiding plate comprising one or more incident surface and one light emitting surface; a reflecting film provided on a side of the light guiding plate opposite to the light emitting surface; and a reflecting type polarizing plate disposed directly on the light emitting surface of the light guiding plate and comprising a metal grating.

Another aspect of the invention provides a liquid crystal display (LCD), comprising: a backlight module; a liquid crystal panel provided on the backlight; and a polarizing plate provided on the display panel. The backlight module comprises a light guiding plate comprising one or more incident surface and one light emitting surface; a reflecting film provided on a side of the light guiding plate opposite to the light emitting surface; and a reflecting type polarizing plate disposed directly on the light emitting surface of the light guiding plate and comprising a metal grating.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from the following detailed description.

### BRIEF DESCRIPTION OF THE DRAWINGS

The present invention will become more fully understood from the detailed description given hereinafter and the accompanying drawings which are given by way of illustration only, and thus are not limitative of the present invention and wherein:

FIG. 1 is a cross sectional view of a LCD having a conventional edge light type backlight module;

FIG. 2 is a cross sectional view of a backlight module for a LCD according to a first embodiment of the present invention;

FIG. 3 is a cross sectional view of a backlight module for a LCD according to a second embodiment of the present invention;

FIG. 4 is a cross sectional view of a backlight module for a LCD according to a third embodiment of the present invention;

FIG. 5 is a cross sectional view of a backlight module for a LCD according to a fourth embodiment of the present invention;

FIG. 6 is a cross sectional view of a backlight module for a LCD according to a fifth embodiment of the present invention; and

FIG. 7 is a cross sectional view of a LCD according to an embodiment of the present invention.

### DETAILED DESCRIPTION OF THE PREFERRED EMBODIMENTS

FIG. 2 is a cross sectional view of a backlight module for a LCD according to a first embodiment of the present invention. The backlight module 100 of the first embodiment of the present invention comprises a frame 11 fixed to a lower portion of an outer cover. A light source 12 is disposed on one side inside the frame 11, and a reflecting plate 13 is provided around the light source 12. The light source 12 may comprise a CCFL or a line of LEDs. Adjacent to the light source 12 is disposed a light guiding plate 15, which comprises one or more incident surfaces and one light emitting surface. A reflecting film 14 is provided under the light guiding plate 15, that is, on a side opposite to the light emitting surface of the light guiding plate 15. In the backlight module 100 according to the first embodiment of the present invention, no optical films (e.g., a diffusing plate, a prism film and the like) are provided on the top of the light guiding plate 15. Instead, a reflecting type polarizing plate 16 comprising a metal grating is provided directly on the light guiding plate.

The reflecting polarizing plate 16 can be fabricated by using a thin-film process. For example, a metal film is deposited on the light emitting surface of the light guiding plate 15, and then grating patterns with a pitch no larger than a half of the wavelength of light irradiated from the light source, i.e., greater than 0 nm and less than 300 nm, is formed by using a photolithographic process. In another example, a metal film is deposited on a transparent substrate and formed into metal grating patterns by using thin-film process, and then the substrate together with the metal grating patterns formed thereon is adhered to the light emitting surface of the light guiding plate 15. Of course, the metal grating can be fabricated by using other methods.

By providing the reflecting type polarizing plate 16 on the light emitting surface of the light guiding plate 15, all the light reflected by the reflecting type polarizing plate 16 enters the light guiding plate 15 again and reflected back by the reflecting film 14 provided under the light guiding plate 15. Thus, a light reflection circulation is realized inside the light guiding plate 15, which enables full use of the reflected light and improves the light utilization efficiency. As compared with the conventional LCD employing an absorbing type polarizing plate, the novel structure of the first embodiment improves the light utilization efficiency and increases the brightness of the LCD by about 50% by means of the reflecting type polarizing plate for realizing the light reflection circulation, though a loss of about 25% of brightness is caused by removing the optical films (e.g., a diffusing plate, a prism film and the like) from the upper side of the light guiding plate 15. As a result, as a whole, the backlight module of the present embodiment can increase the brightness of the LCD by about 25% compared with the conventional backlight module.

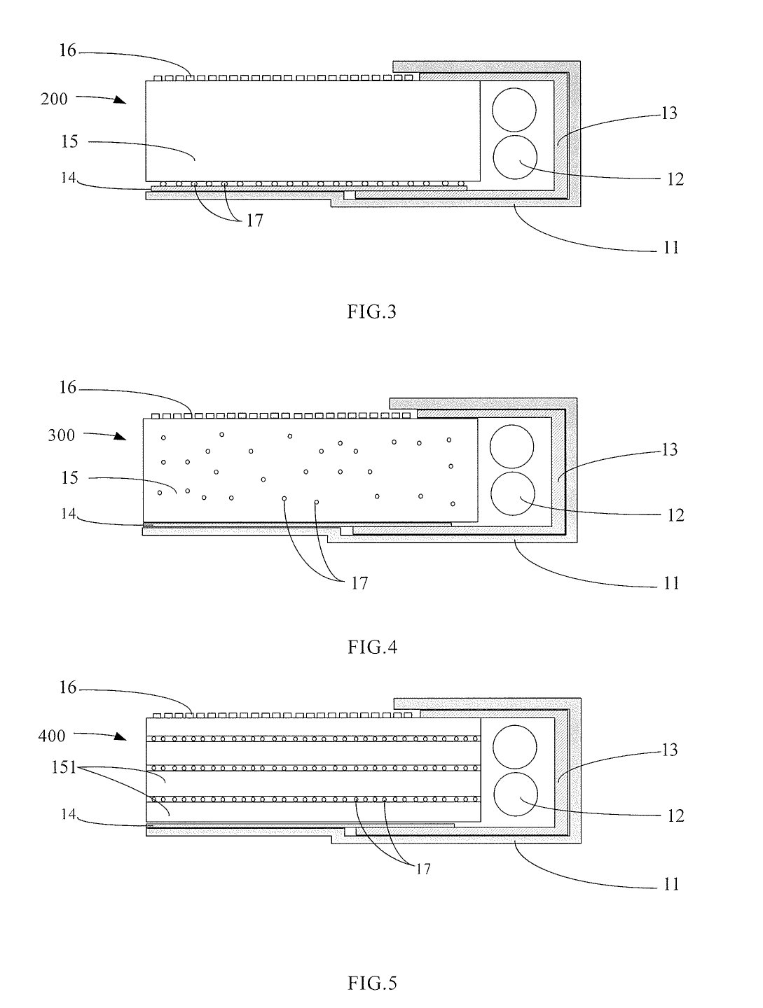

FIG. 3 is a cross sectional view of the backlight module for a LCD according to a second embodiment of the present invention. The backlight module 200 of the present embodiment differs from the backlight module 100 of the first embodiment in that a plurality of diffusing beads 17 are provided between the reflecting film 14 and the light guiding plate 15, forming a layer of diffusing film. Also, the diffusing beads 17 may be disposed inside the reflecting film.

Thus, the light reflected by the reflecting type polarizing plate 16 and the reflecting film 14 is diffused by the diffusing beads 17 to make the light distributed more uniformly, so that the problem caused by the lacking of a diffusing plate in the first embodiment is compensated and the display performance of the LCD can be further improved.

FIG. 4 is a cross sectional view of the backlight module for a LCD according to a third embodiment of the present invention. The backlight module 300 of the present embodiment differs from the backlight module 100 of the first embodiment in that a plurality of diffusing beads 17 are distributed inside the light guiding plate 15 and the light guiding plate 15 has the function of light guiding and diffusing.

Thus, the light circulating inside the light guiding plate 15 is diffused by the diffusing beads 17 to make the light distributed more uniformly, so that the problem caused by the lacking of a diffusing plate in the first embodiment is compensated largely, and the display performance of the LCD is improved to a large extent.

FIG. 5 is a cross sectional view of the backlight module for a LCD according to a fourth embodiment of the present invention. The backlight module 400 of the present embodiment differs from the backlight module 100 of the first embodiment in that the light guiding plate 15 comprises a plurality of thin layers of light guiding films 151, and diffusing beads 17 are disposed between adjacent two layers of light guiding films 151.

Thus, the light circulating inside the light guiding plate 15 is diffused by the diffusing beads 17 to make the light distributed more uniformly, so that the problem caused by the lacking of a diffusing plate in the first embodiment is compensated largely, and the display performance of the LCD is improved to a large extent.

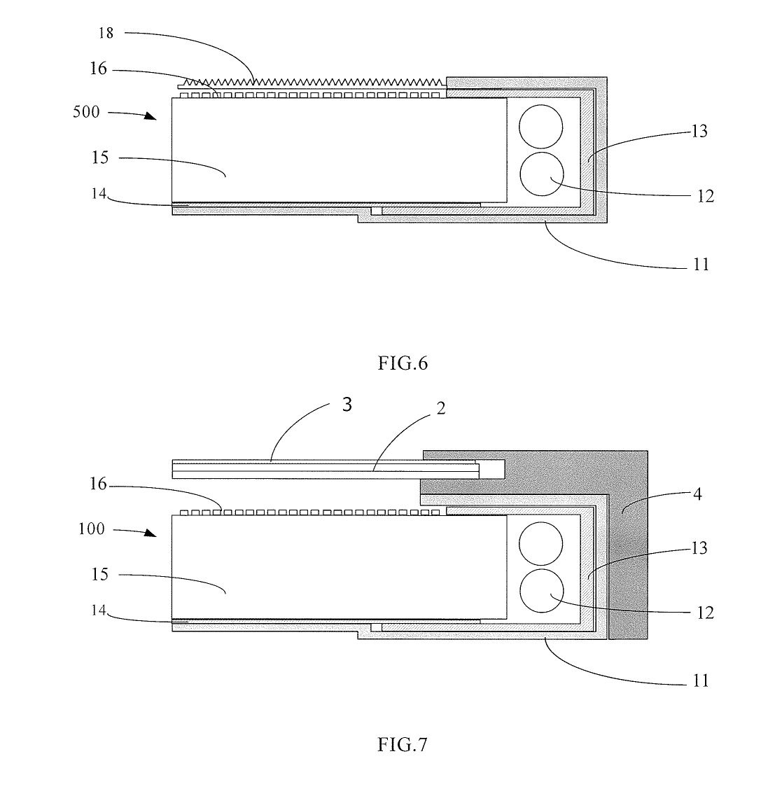

FIG. 6 is a cross sectional view of the backlight module according to a fifth embodiment of the present invention. The backlight module 500 of the present embodiment differs from the backlight module 100 of the first embodiment in that a prism film 18 is further provided on the reflecting type polarizing plate 16.

Accordingly, the prism film 18 improves the light condensation, the luminance and thus the brightness of the LCD. Of course, the prism film may be further provided on the reflecting type polarizing plate of the backlight module according to the second to the fourth embodiments to improve the brightness.

FIG. 7 is a cross sectional view of the LCD according to an embodiment of the present invention.

As shown in FIG. 7, the LCD of the present embodiment comprises a cover 4, a display panel 2 held by the upper portion of the cover 4, a polarizing plate 3 disposed on the top of the display panel 2, and the backlight module 100 according to the first embodiment of the present invention mounted in the lower portion of the cover 4.

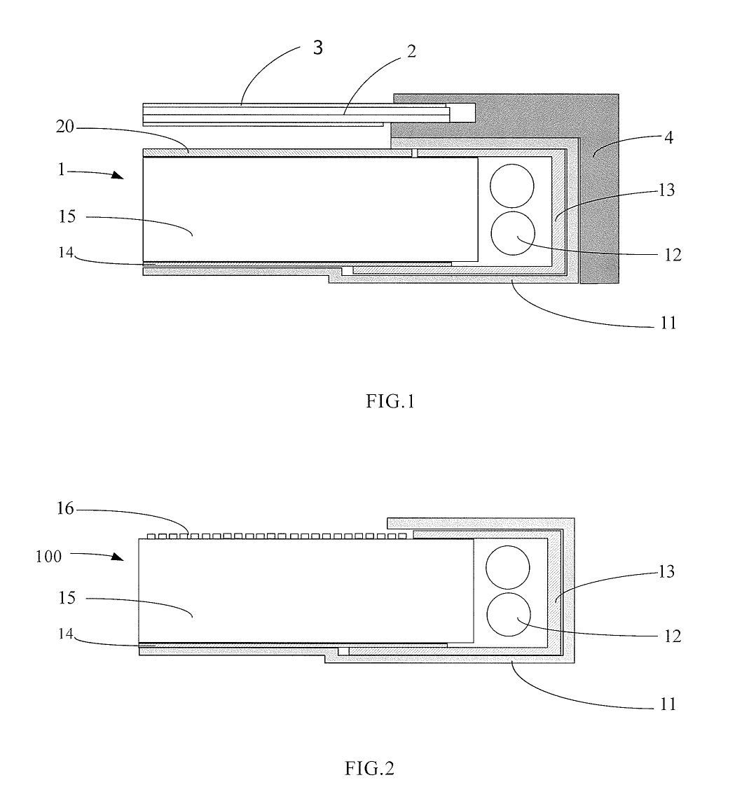

In comparison to the conventional LCD shown in FIG. 1, the LCD of the present embodiment does not have the lower polarizing plate and the optical films by using the backlight module of the first embodiment with improved characteristics. In particular, in order to improve the light utilization efficiency, the embodiment of the present invention substitutes the conventional absorbing type polarizing plate with a reflecting type polarizing plate in a backlight module. However, if the reflecting type polarizing plate and optical films are provided under the bottom of the panel, the light reflected by the reflecting type polarizing plate will be blocked by the optical films and thus cannot be efficiently circulated to use due to the presence of the optical films. Therefore, in the embodiments of the invention, the reflecting type polarizing plate is disposed directly on the light guiding plate, so that light reflection circulation is realized by using the reflecting film under the light guiding plate. On the other hand, if the conventional optical films are disposed above the reflecting type polarizing plate, the polarized light obtained through the polarizing plate will be scattered by the optical films, which degrades the function of the polarizing plate. Therefore, the optical films are not disposed above the polarizing plate also. Thus, though a loss of about 25% of brightness is caused by the removing of the optical films, the light utilization efficiency is improved by means of the reflecting type polarizing plate for realizing the light reflection circulation, increasing the brightness of the LCD by about 50%. Consequently, as a whole, the backlight module of the present embodiment increases the brightness of the LCD by about 25%.

In addition, the LCD of the present invention can also employ the backlight modules according to the second to the fifth embodiments discussed above. The display performance of the LCD of the present invention can be further improved by employing the backlight modules of the second to the fifth embodiments.

As can be seen from the above mentioned, the LCD of the embodiments of present invention and the backlight module therefor have the following beneficial effects:

1. The reflecting type polarizing plate directly disposed on the light guiding plate makes almost all the light reflected by the reflecting type polarizing plate enter into the light guiding plate again and be reflected back by the reflecting film under the light guiding plate, so that the light reflection circulation is realized inside the light guiding plate to fully circulate and use the reflected light, and accordingly the light utilization efficiency is largely improved. In comparison to the conventional LCD using an absorbing type polarizing plate, for the backlight of the embodiments of the invention, though a loss of about 25% of brightness is caused by the removing of the optical films, the light utilization efficiency is improved by using the reflecting type polarizing plate for realizing light reflection circulation, increasing the brightness of the LCD by about 50%. Consequently, as a whole, the backlight module of the present embodiment increases the brightness of the LCD by about 25%.

2. In the embodiments of the present invention, diffusing beads can be further provided between the light guiding plate and the reflecting film. As a result, the light reflected by the reflecting type polarizing plate and the reflecting film can be diffused by the diffusing beads to make the light distributed more uniformly, thereby improving the display performance of the LCD.

3. The light inside the light guiding plate can be circulated by using a light guiding plate having the function of diffusion. With the diffusion of the diffusing beads, the light can be distributed more uniformly, which largely improves the display performance of the LCD. The brightness of the LCD is also improved to a large extent.

4. A prism film can be further provided on the reflecting type polarizing plate, thereby improving the brightness of the LCD.

The embodiment of the invention being thus described, it will be obvious that the same may be varied in many ways. Such variations are not to be regarded as a departure from the spirit and scope of the invention, and all such modifications as would be obvious to those skilled in the art are intended to be comprised within the scope of the following claims.

What is claimed is:

1. A backlight module for a liquid crystal display, comprising:
a light guiding plate comprising one or more incident surface and one light emitting surface;
a reflecting film provided on a side of the light guiding plate opposite to the light emitting surface; and
a reflecting type polarizing plate disposed directly on the light emitting surface of the light guiding plate and comprising a metal grating.

2. The backlight module of claim 1, wherein the metal grating of the reflecting type polarizing plate has a pitch of greater than 0 nm and less than 300 nm.

3. The backlight module of claim 1, wherein the metal grating is formed directly on the light emitting surface of the light guiding plate by using a thin-film process.

4. The backlight module of claim 2, wherein the metal grating is formed directly on the light emitting surface of the light guiding plate by using a thin-film process.

5. The backlight module of claim 1, wherein the reflecting type polarizing plate further comprises a transparent substrate, the metal grating is formed on the transparent substrate, and the transparent substrate is provided directly on the light emitting surface of the light guiding plate.

6. The backlight module of claim 2, wherein the reflecting type polarizing plate further comprises a transparent substrate, the metal grating is formed on the transparent substrate, and the transparent substrate is provided directly on the light emitting surface of the light guiding plate.

7. The backlight module of claim 1, further comprising diffusing beads provided between the reflecting film and the light guiding plate.

8. The backlight module of claim 1, wherein diffusing beads are distributed inside the light guiding plate.

9. The backlight module of claim 1, wherein the light guiding plate comprises a plurality of layers of light guiding films, and diffusing beads are provided between every two adjacent layers of light guiding films.

10. The backlight module of claim 1, wherein the backlight module further comprises a prism film disposed on the reflecting type polarizing plate.

11. A liquid crystal display (LCD), comprising:
a backlight module;
a liquid crystal panel provided on the backlight; and
a polarizing plate provided on the display panel;
wherein the backlight module comprises a light guiding plate comprising one or more incident surface and one light emitting surface; a reflecting film provided on a side of the light guiding plate opposite to the light emitting surface; and a reflecting type polarizing plate disposed directly on the light emitting surface of the light guiding plate and comprising a metal grating.

12. The LCD of claim 11, wherein the metal grating of the reflecting type polarizing plate has a pitch of greater than 0 nm and less than 300 nm.

13. The LCD of claim 11, wherein the metal grating is formed directly on the light emitting surface of the light guiding plate by using a thin-film process.

14. The LCD of claim 12, wherein the metal grating is formed directly on the light emitting surface of the light guiding plate by using a thin-film process.

15. The LCD of claim 11, wherein the reflecting type polarizing plate further comprises a transparent substrate, the metal grating is formed on the transparent substrate, and the transparent substrate is provided directly on the light emitting surface of the light guiding plate.

16. The LCD of claim 12, wherein the reflecting type polarizing plate further comprises a transparent substrate, the metal grating is formed on the transparent substrate, and the transparent substrate is provided directly on the light emitting surface of the light guiding plate.

17. The LCD of claim 11, further comprising diffusing beads provided between the reflecting film and the light guiding plate.

18. The LCD of claim 11, wherein diffusing beads are distributed inside the light guiding plate.

19. The LCD of claim 11, wherein the light guiding plate comprises a plurality of layers of light guiding films, and diffusing beads are provided between every two adjacent layers of light guiding films.

20. The LCD of claim 11, wherein the backlight module further comprises a prism film disposed on the reflecting type polarizing plate.
